(19) United States
(12) Patent Application Publication
(10) Pub. No.: US 2024/0326192 A1
(43) Pub. Date: Oct. 3, 2024

(54) MITER SAW WITH FOLDING POWER-OFF PROTECTION FUNCTION

(71) Applicant: REXON INDUSTRIAL CORP., LTD., Taichung (TW)

(72) Inventors: Cheng-Hsun TSAI, Taichung (TW); Yi-Ting KO, Taichung (TW)

(73) Assignee: REXON INDUSTRIAL CORP., LTD., Taichung (TW)

(21) Appl. No.: 18/191,253

(22) Filed: Mar. 28, 2023

(51) Int. Cl. B23Q 13/00; B23D 45/14; B23D 45/16; B23Q 5/58; B23Q 11/00

(52) U.S. Cl. CPC B23Q 13/00; B23D 45/14; B23D 45/16; B23Q 5/58; B23Q 11/0089

(57) ABSTRACT

A miter saw includes a base seat unit, a cutting unit rotatable relative to the base seat unit to bring a saw blade to rotate among a first working state, a second working state and a folded state, and a safety unit having at least one slide slot and a movable pin slidable along the slide slot. When the saw blade is in one of the first and second working states, the movable pin is retained in a first slot portion of the slide slot to permit operation of a trigger. When the saw blade is in the folded state, the movable pin is retained in a second slot portion of the slide slot to lock the trigger.

### FIELD

The disclosure relates to a miter saw, and more particularly to a miter saw with a folding power-off protection function.

### BACKGROUND

A conventional miter saw generally includes a machine base, a worktable rotatably mounted on the machine base, a cutting unit and a positioning unit disposed at a side of the worktable. The machine base has a base seat and two legs connected at two sides of the base seat. The positioning unit has a rotary shaft which is threadedly mounted on the worktable, and is operable to permit rotation of the worktable relative to the base seat for adjusting a cutting angle of the cutting unit.

Another conventional miter saw includes a cutting unit which is tiltably positioned relative to a worktable by means of an angle positioning plate and a locking unit such that a saw blade of the cutting unit is positioned at a predetermined tilted angle relative to the worktable.

Both of these conventional miter saws are foldable to facilitate storage and carry. However, when it is desired to fold or carry the miter saw, an operator may accidentally operate a triggering switch by mistake, which will cause rotation of the saw blade and endanger the operator.

### SUMMARY

Therefore, an object of the disclosure is to provide a miter saw that can alleviate at least one of the drawbacks of the prior art.

According to the disclosure, the miter saw includes a base seat unit, a cutting unit and a safety unit. The base seat unit includes a worktable which has a working surface, and a pivot seat which is connected with the worktable. The pivot seat defines a pivot axis. The cutting unit includes a support arm which is pivotably mounted on the pivot seat about the pivot axis, a saw blade which is rotatably mounted on the support arm to be rotated about a blade axis, a driver which is mounted on the support arm to drive rotation of the saw blade, a trigger which is pivotably mounted on the support arm, and a switch which is mounted on the support arm and which is triggered by the trigger to turn-on and turn-off the driver. The cutting unit is operated to rotate relative to the pivot seat about the pivot axis to rotate the saw blade relative to the working surface among a first working state, where the saw blade is disposed substantially perpendicular to the working surface, a second working state, where the saw blade is tilted relative to the working surface, and a folded state, where the saw blade is disposed substantially parallel to and close to the working surface. The safety unit is mounted on the support arm adjacent to the trigger. The safety unit includes at least one slide slot and a movable pin which is engaged with and slidable along the slide slot. The slide slot has a first slot portion, a second slot portion which is opposite to the first slot portion in a first direction that is substantially parallel to the blade axis, and a curve slot portion which interconnects the first and second slot portions. The safety unit has a retaining portion which is bordered by the curve slot portion and a reference plane that passes through the first slot portion and the second slot portion.

When the saw blade is disposed in the first working state to have the blade axis be substantially parallel to the working surface, the movable pin is obstructed by the retaining portion and retained to the first slot portion, and the trigger is operable to trigger the switch. When the saw blade is disposed in the second working state to have the blade axis extending to inclinedly intersect an extension plane of the working surface, the movable pin is obstructed by the retaining portion and retained to the first slot portion, and the trigger is operable to trigger the switch. When the saw blade is rotated from the second working state to the folded state to have the blade axis extending to substantially intersect the extension plane of the working surface perpendicularly, the movable pin is moved, by its weight, through the curve slot portion, to the second slot portion below the first slot portion, and the movable pin locks the trigger to prevent operation of the trigger for triggering the switch.

With the slide slot and the movable pin slidably engaged with the slide slot, when the saw blade is disposed in one of the first and second working states, the movable pin is retained by the retaining portion to the first slot portion so as to permit operation of the trigger. When the saw blade is moved to the folded state relative to the working surface, the movable pin is moved, by its weight, through the curve slot portion to the second slot portion so as to lock the trigger for power-off protection when folded.

### BRIEF DESCRIPTION OF THE DRAWINGS

Other features and advantages of the disclosure will become apparent in the following detailed description of the embodiment with reference to the accompanying drawings. It is noted that various features may not be drawn to scale.

FIG. 1 is a perspective view illustrating an embodiment of a miter saw according to the disclosure in a state when a saw blade is in a first working state relative to a working surface.

FIG. 2 is a fragmentary perspective view illustrating a support arm and a safety unit of the embodiment, a second housing half of the support arm being removed for sake of clarity.

FIG. 3 is an exploded perspective view of FIG. 2.

FIG. 4 is a fragmentary schematic view illustrating the saw blade in the first working state.

FIG. 5 is a sectional view taken from line V-V of FIG. 4.

FIG. 6 is a sectional view taken from line VI-VI of FIG. 5.

FIG. 7 is a sectional view taken from line VII-VII of FIG. 5.

FIG. 8 is a perspective view illustrating the saw blade in a second working state relative to the working surface.

FIG. 9 is a fragmentary perspective view illustrating a portion of the embodiment of FIG. 8.

FIG. 10 is a schematic view illustrating the saw blade in the second working state relative to the working surface.

FIG. 11 is a sectional view taken from line XI-XI of FIG. 10.

FIG. 12 is a sectional view taken from line XII-XII of FIG. 11.

FIG. 13 is a perspective view illustrating the saw blade in a folded state and substantially parallel to the working surface.

FIG. 14 is a fragmentary perspective view illustrating a portion of the embodiment of FIG. 13.

FIG. 15 is a schematic view illustrating the saw blade in the folded state.

FIG. 16 is a sectional view taken from line XVI-XVI of FIG. 15.

FIG. 17 is a sectional view taken from line XVII-XVII of FIG. 16.

FIG. 18 is a sectional view taken from line XVIII-XVIII of FIG. 16.

FIG. 19 is a fragmentary perspective view of FIG. 16.

### DETAILED DESCRIPTION

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

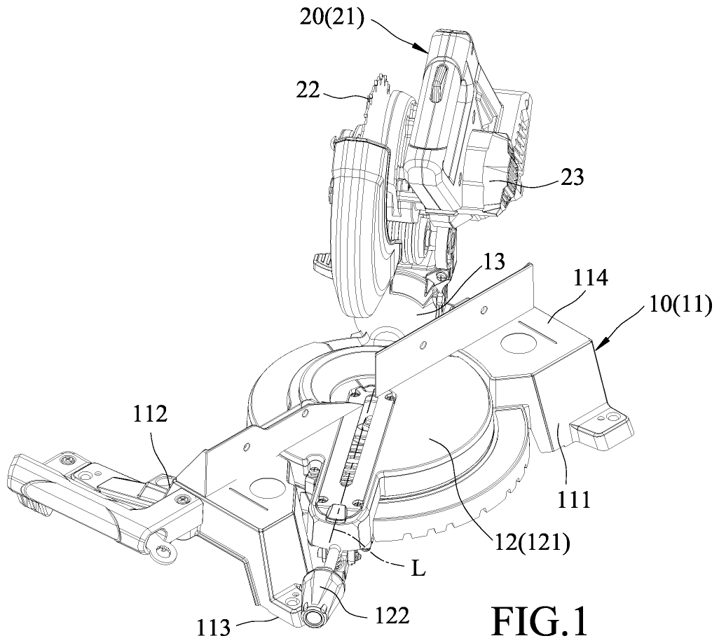

Referring to FIGS. 1 to 3, an embodiment of a miter saw according to the disclosure includes a base seat unit 10, a cutting unit 20 and a safety unit 30.

The base seat unit 10 includes a base seat 11, a worktable 12 which is rotatably mounted on the base seat 11, and a pivot seat 13 which is connected with the worktable 12. The base seat 11 has a front side edge 111, a rear side edge 112 opposite to the front side edge 111, a bottom wall 113 extending from the front side edge 111 to the rear side edge 112, a top wall 114 opposite to the bottom wall 113. The worktable 12 has a working surface 121 which is mounted at the top wall 114, and an operating handle 122 which is mounted opposite to the pivot seat 13. The pivot seat 13 defines a pivot axis (L) that extends from the rear side edge 112 toward the front side edge 111 and that is parallel to the working surface 121.

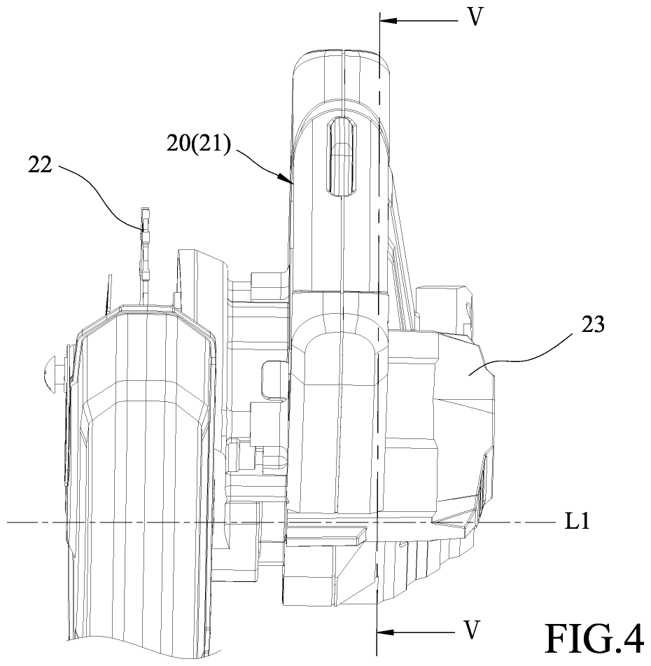

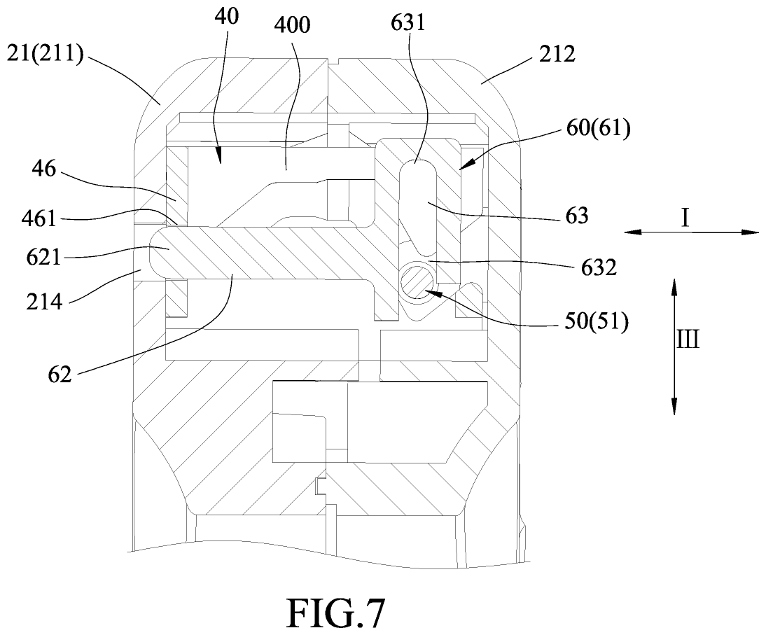

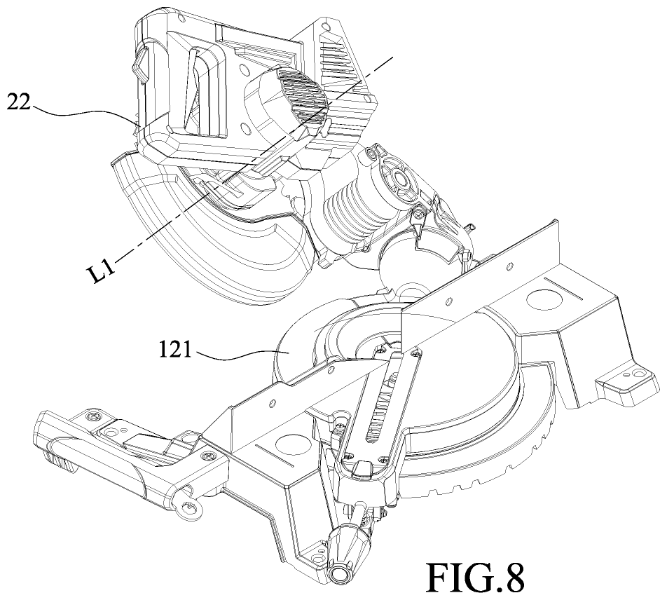

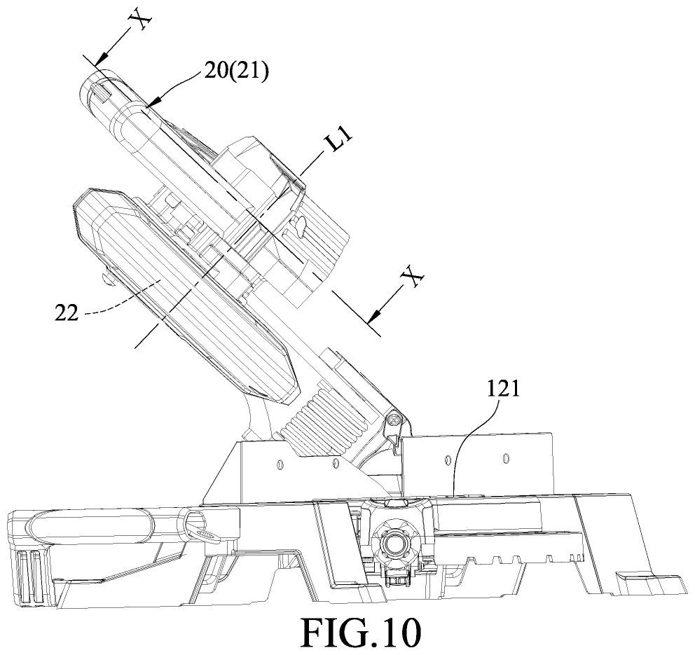

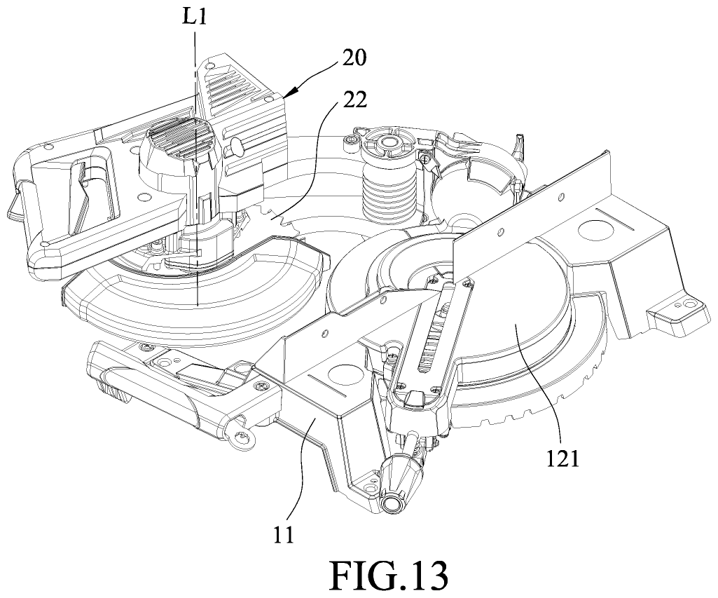

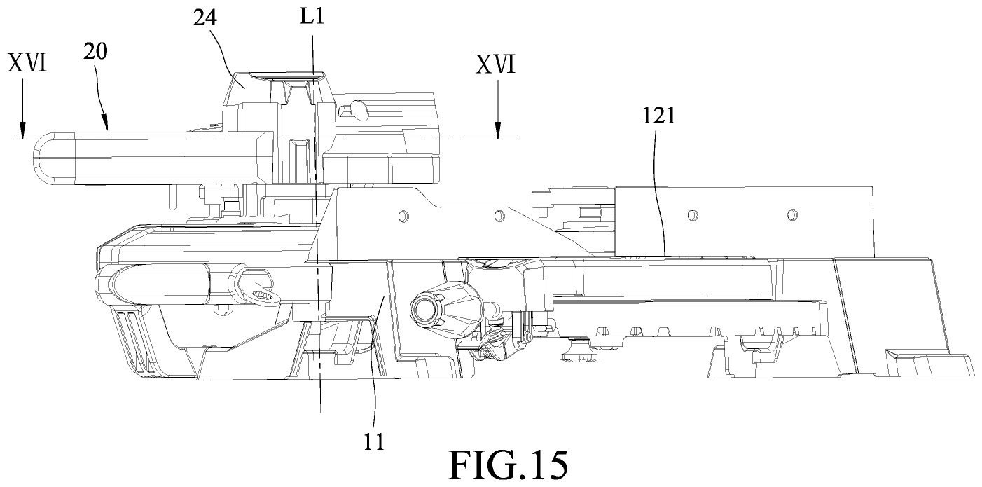

The cutting unit 20 includes a support arm 21 which is pivotably mounted on the pivot seat 13 about the pivot axis (L) to be rotatable relative to the base seat unit 10, a saw blade 22 which is rotatably mounted on the support arm 21 to be rotated about a blade axis (L1), a driver 23 which is mounted on the support arm 21 to drive rotation of the saw blade 22, a trigger 24 which is pivotably mounted on the support arm 21 and which is disposed adjacent to the saw blade 22 and the driver 23, and a switch 25 which is mounted on the support arm 21 and which is triggered by the trigger 24 to turn-on and turn-off the driver 23. Hence, the cutting unit 2 is operated to rotate relative to the pivot seat 13 about the pivot axis (L) to rotate the saw blade 22 relative to the working surface 121 among a first working state (see FIGS. 1 and 4), where the saw blade 22 is disposed substantially perpendicular to the working surface 121, a second working state (see FIGS. 8 and 10), where the saw blade 22 is tilted relative to the working surface 121, and a folded state (see FIGS. 13 and 15), where the saw blade 22 is disposed substantially parallel to and close to the working surface 121. The support arm 21 has a first housing half 211 and a second housing half 212 coupled with each other. The first housing half 211 has a socket portion 213, a through hole 214 (see FIG. 7) formed therethrough to be in communication with the socket portion 213, and a bracket 215 formed adjacent to the socket portion 213. The trigger 24 has a pivot end 241 which is pivotally connected with the first housing half 211, and a swing end 242 opposite to the pivot end 241 and adjacent to the switch 25. The swing end 242 has a retained portion 243 and a protrusion 244 which protrudes from the retained portion 243.

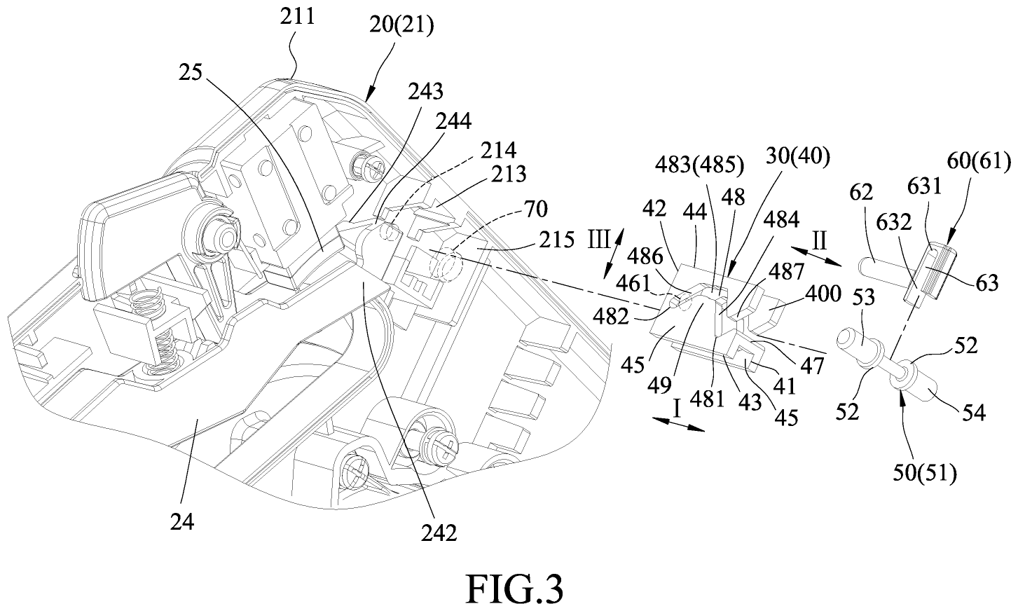

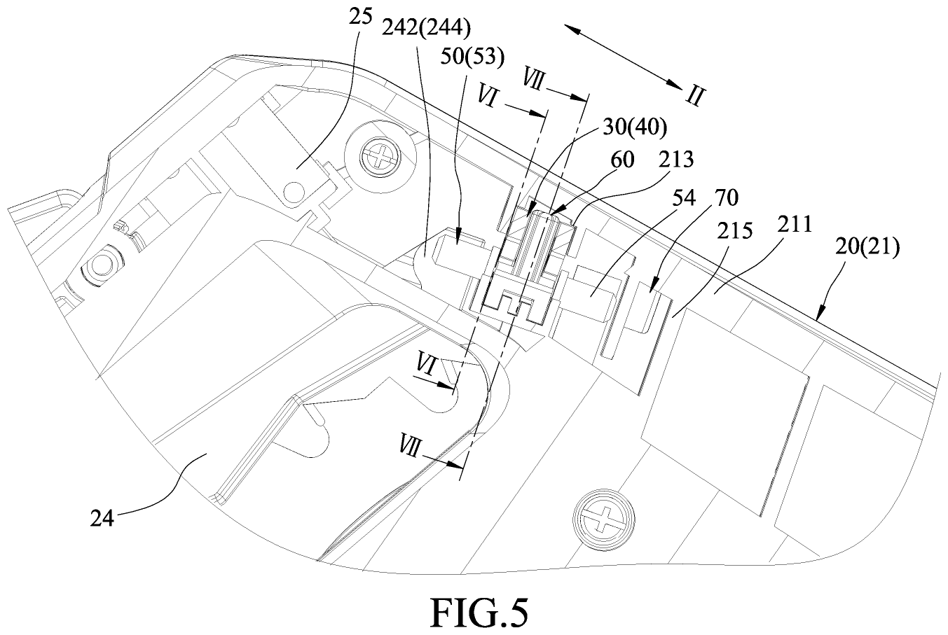

With reference to FIGS. 3, 5 and 6, the safety unit 30 is mounted on the support arm 21 adjacent to the trigger 24. The safety unit 30 includes a slot forming seat 40 which is securely mounted within the socket portion 213, a movable pin 50 which is slidably disposed on the slot forming seat 40, a returning member 60 which is slidably disposed on the slot forming seat 40, and a magnet member 70 which is securely disposed on the support arm 21 at a side of the slot forming seat 40 (see FIG. 3).

The slot forming seat 40 is in the form of a cuboid, and has a first side 41, a second side 42 opposite to the first side 41 in a first direction (I) that is substantially parallel to the blade axis (L1), a lower end 43 connected between the first and second sides 41, 42, and an upper end 44 opposite to the lower end 43. Specifically, the slot forming seat 40 includes two upright walls 45 which are spaced apart from each other in a second direction (II) that is perpendicular to the first direction (I), a connecting wall 46 (see FIG. 7) which interconnects the upright walls 45, a connecting rib 47 which interconnects the upright walls 45 and which is spaced apart from the connecting wall 46 in the first direction (I), and two slide slots 48 which are respectively formed in the upright walls 45 and which extend from the first side 41 toward the second side 42. The upright walls 45, the connecting wall 46 and the connecting rib 47 cooperatively define a guide slot 400 thereamong. The connecting wall 46 has a through hole 461 (see FIG. 7) which extends therethrough and is in communication with the guide slot 400. The through hole 461 is aligned with the through hole 214 of the first housing half 211 (see FIG. 7).

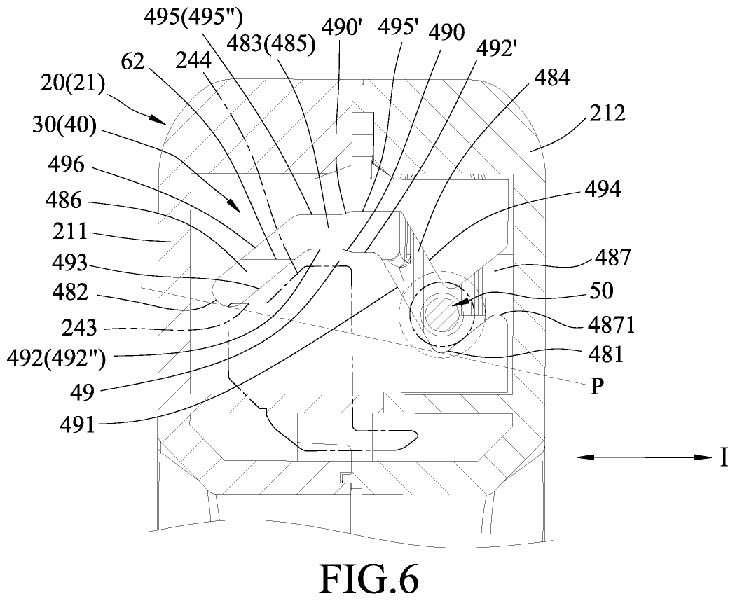

With reference to FIG. 6, each of the slide slots 48 has a first slot portion 481 proximate to the first side 41, a second slot portion 482 which is opposite to the first slot portion 481 in the first direction (I) and proximate to the second side 42, and a curve slot portion 483 which interconnects the first and second slot portions 481, 482. Additionally, each slide slot 48 has a first inclined slot section 484 which is formed adjacent to the first side 41, a crossing slot section 485 which is formed adjacent to the upper end 44 and in communication with the first inclined slot section 484, a second inclined slot section 486 which is formed adjacent to the second side 42 and in communication with the crossing slot section 485, and an entrance section 487 which extends from the first side 41 to be in communication with the first inclined slot section 484. Specifically, the first slot portion 481 is disposed in the lowermost end of the first inclined slot section 484 adjacent to the lower end 43, and is formed at the junction of the first inclined slot section 484 and the entrance section 487. The first inclined slot section 484 extends from the first slot portion 481 towards the crossing slot section 485 and away from the first side 41. The second slot portion 482 is disposed in the lowermost end of the second inclined slot section 486 and adjacent to the second side 42. The second inclined slot section 486 extends from the second slot portion 482 towards the crossing slot section 485 and away from the second side 42. The first inclined slot section 484, the crossing slot section 485 and the second inclined slot section 486 cooperatively define the curve slot portion 483. The entrance section 487 has at the first side 41 an access port 4871 which is located at a position between the first slot portion 481 and the upper end 44 in height. Hence, the entrance section 487 and the first inclined slot section 484 are cooperatively formed with a cross-section of a V-shape. Also, each of the upright walls 45 has a retaining portion 49 of a substantially trapezoidal shape which is bordered by the curve slot portion 483 and a reference plane (P) that passes through the first slot portion 481 and the second slot portion 482. Specifically, the retaining portion 49 has a first inner inclined edge 491 which borders a lower end of the first inclined slot section 484, an inner crossing edge 492 which borders a lower end of the crossing slot section 485, and a second inner inclined edge 493 which borders a lower end of the second inclined slot section 486. The inner crossing edge 492 is in the form of a ramped step, and includes an inner lower edge segment (492′) which is proximate to the first inclined slot section 484, an inner higher edge segment (492″) which is proximate to the second inclined slot section 486, and an inner inclined edge segment 490 which interconnects the inner lower and higher edge segments (492′, 492″). Further, each upright wall 45 has a first outer inclined edge 494, an outer crossing edge 495 and a second outer inclined edge 496. The first outer inclined edge 494 is spaced apart from the first inner inclined edge 491 to border an upper end of the first inclined slot section 484. The outer crossing edge 495 is spaced apart from the inner crossing edge 492 to border an upper end of the crossing slot section 485. The second outer inclined edge 496 is spaced apart from the second inner inclined edge 493 to border an upper end of the second inclined slot section 486. The outer crossing edge 495 is in the form of an inverted step, and includes an outer higher edge segment (495′) which is proximate to the first inclined slot section 484, an outer lower edge segment (495″) which is proximate to the second inclined slot section 486, and an outer inclined edge segment (490′) which interconnects the outer higher and lower edge segments (495′, 495″). Moreover, as shown in FIG. 6, when the slot forming seat 40 is securely mounted within the socket portion 213, the retained portion 243 of the trigger 24 is disposed proximate to the second slot portion 482, and the protrusion 244 is disposed proximate to the retaining portion 49.

The movable pin 50 has a shaft 51 which extends in the second direction (II), two discs 52 which are respectively connected with two ends of the shaft 51, an interfering portion 53 which extends from one of the discs 52 in the second direction (II), and a magnetically attractive portion 54 which is connected with and extends from the other one of the discs 52 in the second direction (II). The shaft 51 is inserted into the slide slots 48 from the entrance sections 487 to have the discs 52 respectively disposed outwardly of and abutting against the upright walls 45. Thus, the movable pin 50 is engaged with and slidable along the slide slots 48.

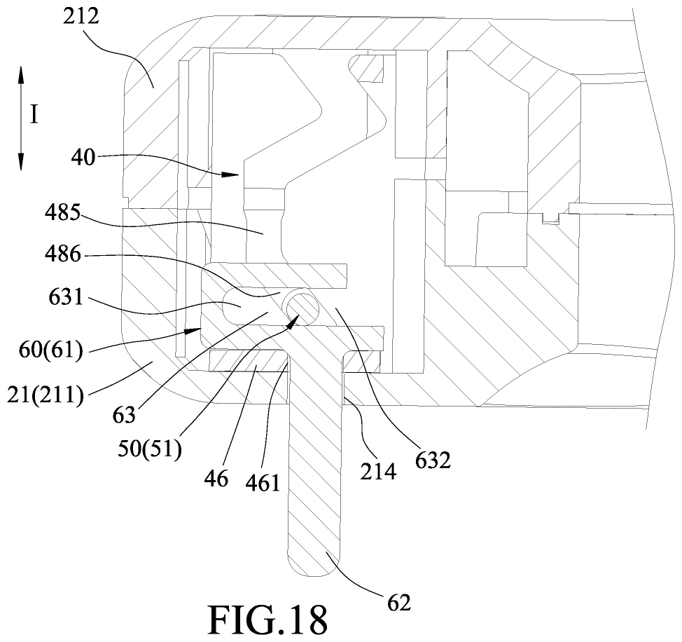

The returning member 60 has a movable piece 61 which is received in and movable along the guide slot 400 in the first direction (I) (see FIGS. 3 and 7), and an operated rod 62 which is connected with the movable piece 61 to be movably engaged in the through holes 461, 214. Specifically, the movable piece 61 has an inverted-U shaped cross-section, and has an elongated slot 63 which extends in a third direction (III) that is perpendicular to both the first direction (I) and the second direction (II) such that the shaft 51 of the movable pin 50 is engaged in and movable along the elongated slot 63. The elongated slot 63 has an upper closed end 631 and a lower opened end 632 which are disposed proximate to the upper and lower ends 44, 43, respectively. The operated rod 62 has an operated end 621 which extends into the through holes 461, 214 to project outwardly of the support arm 21 when the movable pin 50 is moved toward the second side 42 (see FIG. 18).

The magnet member 70 is securely disposed on the bracket 215. The magnetically attractive portion 54 of the movable pin 50 is retained by the magnet member 70 when the movable pin 50 is moved toward the second side 42.

In operation, referring to FIG. 1 which illustrates that the saw blade 22 of the cutting unit 20 is in the first working state, the worktable 12 and the cutting unit 20 are turned relative to the base seat 11 by operating the operating handle 122 so as to be moved to a desired cutting angle. In this state, the driver 23 is suspended above the working surface 121 of the worktable 12. The operator then controls and rotates the support arm 21 to bring the saw blade 22 toward the working surface 121 for cutting a workpiece (not shown) placed on the working surface 121.

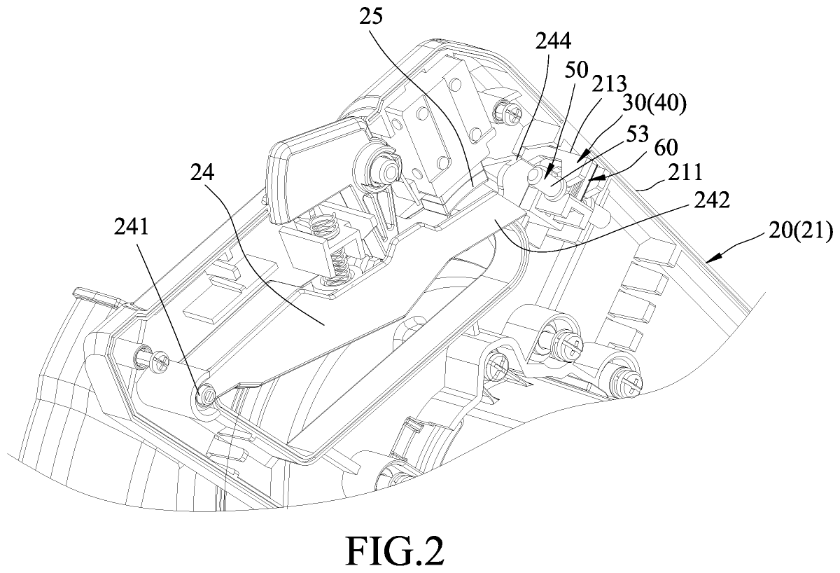

With reference to FIGS. 2, 4, 5, 6 and 7, when the saw blade 22 is disposed in the first working state, the blade axis (L1) is substantially parallel to the working surface 121, the movable pin 50 is obstructed by the retaining portions 49 and retained to the first slot portions 481 of the slide slots 48, and the interfering portion 53 is disposed outwardly of the protrusion 244 of the trigger 24 so as not to interfere with the swing end 242 of the trigger 24 (see FIGS. 2 and 6). Thus, the trigger 24 is operable to trigger the switch 25 for actuating the driver 23. In this state, the operated end 621 of the operated rod 62 is disposed in the first housing half 211 of the support arm 21 (see FIG. 7).

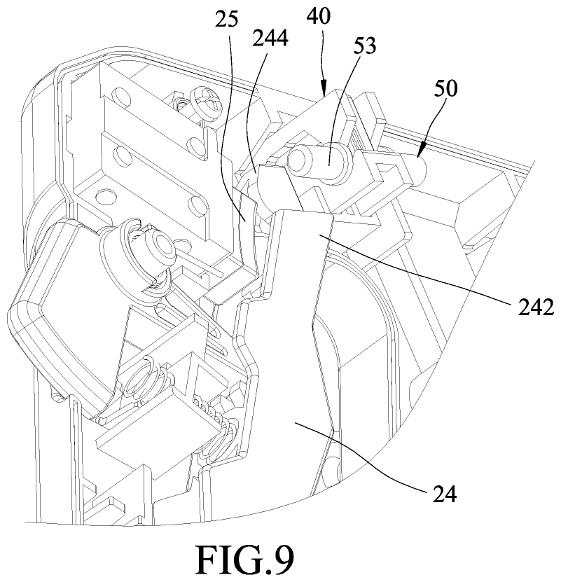

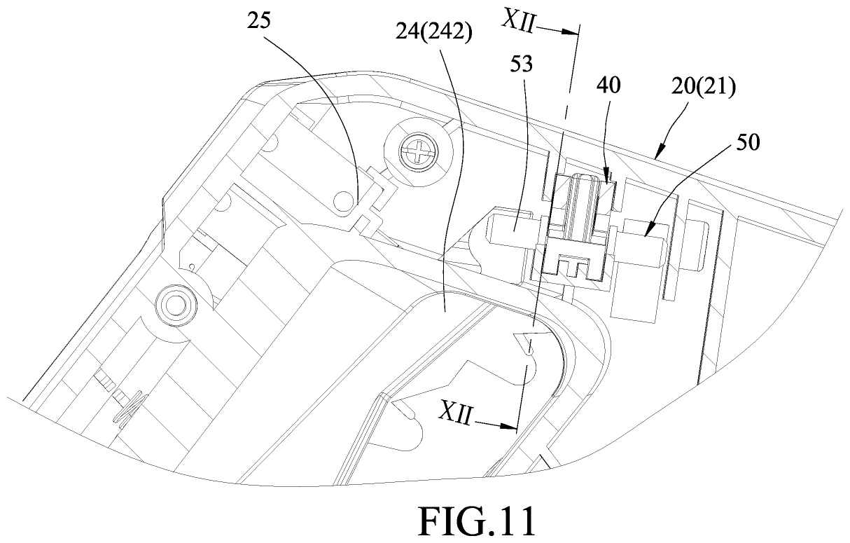

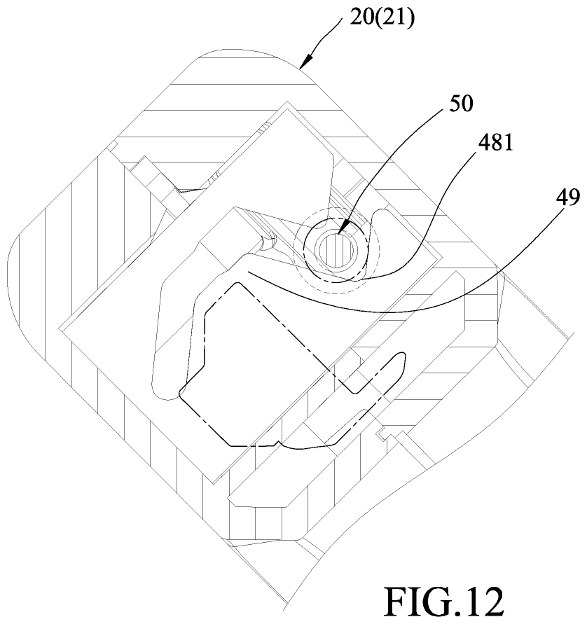

With reference to FIGS. 8 to 12, when the saw blade 22 is disposed in the second working state to have the blade axis (L1) extending to inclinedly intersect an extension plane of the working surface 121, the slot forming seat 40 is tilted about 45 degrees, the movable pin 50 is still obstructed by the retaining portions 49 and retained to the first slot portions 481 of the slide slots 48 (see FIG. 12) such that the interfering portion 53 is still disposed outwardly of the protrusion 244 of the trigger 24 so as to not interfere with the swing end 242 of the trigger 24, and the trigger 24 is operable to trigger the switch 25. In this state, the operated end 621 of the operated rod 62 is disposed in the first housing half 211 of the support arm 21.

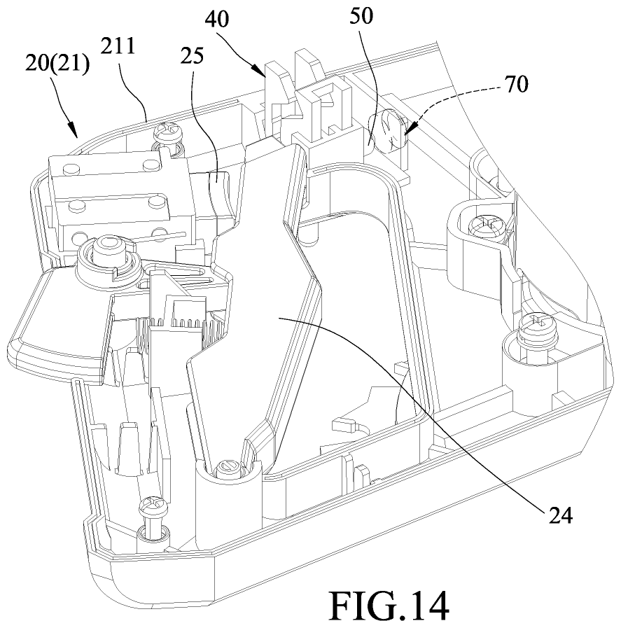

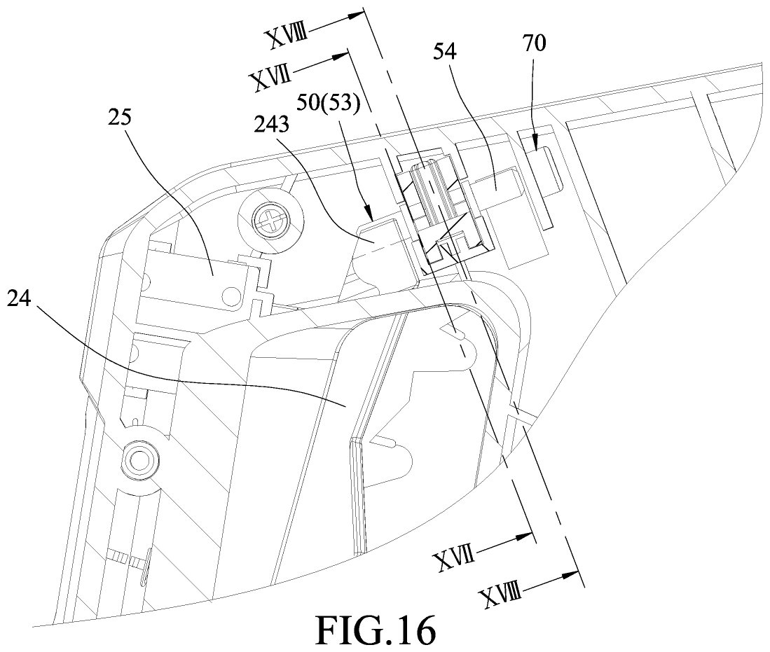

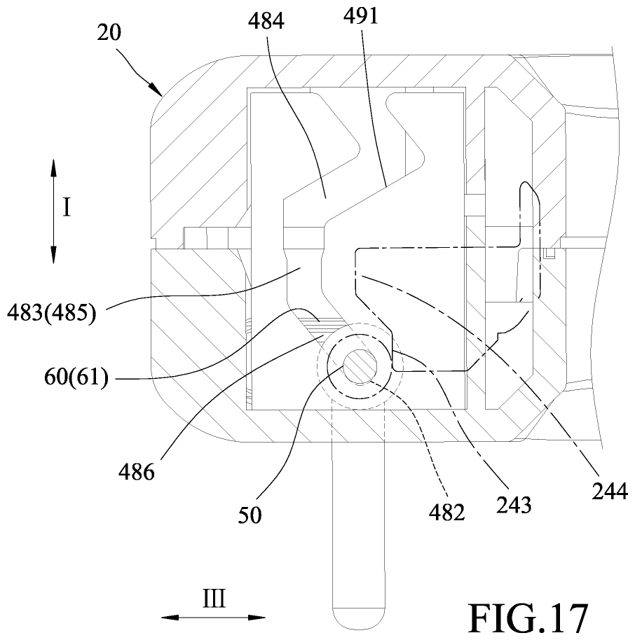

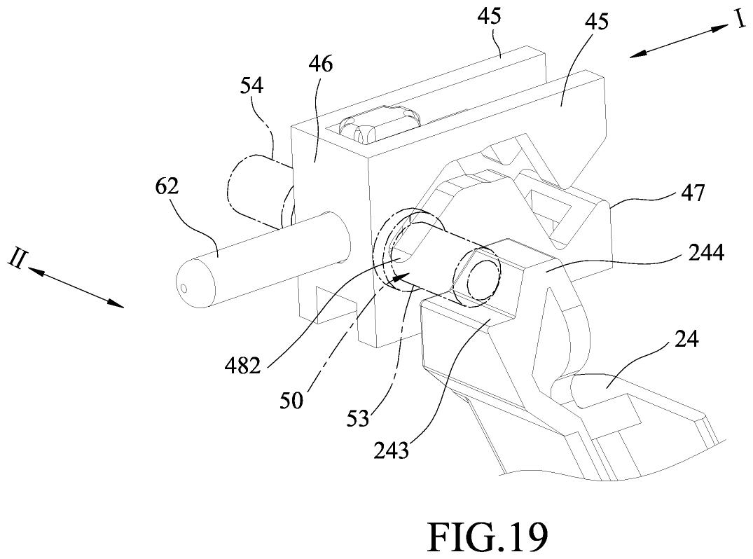

When it is desired to fold and store the miter saw, with reference to FIGS. 13 to 18, the cutting unit 20 is folded toward the base seat 11, and the saw blade 22 is moved to the folded state to have the blade axis (L1) extending to substantially intersect the extension plane of the working surface 121 perpendicularly (see FIG. 13). The movable pin 50 is guided and moved, by its weight, along the first inner inclined edge 491, from the first inclined slot section 484 toward the crossing slot section 485, and is subsequently moved from the crossing slot section 485 toward the second inclined slot section 486. That is, the movable pin 50 is moved, through the curve slot portion 483, to the second slot portion 482 that is below the first slot portion 481 (see FIG. 17). Meanwhile, the magnetically attractive portion 54 of the movable pin 50 is retained by the magnet member 70 (see FIG. 16), and the interfering portion 53 is disposed at a side of the retained portion 243 of the trigger 24 and is engaged with the retained portion 243 (see FIG. 19) to lock the trigger 24 so as to prevent operation of the trigger 24 for triggering the switch 25. The driver 23 is kept in a power-off state. Also, with the the magnet member 70 retaining the magnetically attractive portion 54 via magnetic attraction, the movable pin 50 is retained firmly at the second slot portion 482 during transportation and carrying of the miter saw.

During the movement of the movable pin 50 along the slide slots 48, with the returning member 60 which is connected and moved with the shaft 51 only in the first direction (I) and permits the movement of the shaft 51 in the third direction (III), the movement of the movable pin 50 along the slide slots 48 is smooth, while the returning member 60 is moved to project the operated end 621 of the operated rod 62 outwardly of the first housing half 211 of the support arm 21 (see FIG. 18).

When the cutting unit 20 is rotated from the second working state toward the folded state, with the inner inclined edge segment 490 interconnecting the inner lower and higher edge segments (492′, 492″) and the outer inclined edge segment (490′) interconnecting the outer higher and lower edge segments (495′, 495″), the movable pin 50 is smoothly and successfully moved from the crossing slot section 485 toward the second inclined slot section 486.

When the miter saw is operated from the folded state to the first or second working state, the operated end 621 of the operated rod 62 is pressed (see FIG. 18) to move the movable pin 50 through the movable piece 61 from the second slot portion 482 to the first slot portion 481 (see FIG. 7) so as to remove the interfering portion 53 from the protrusion 244 of the trigger 24 for unlocking the trigger 24.

Therefore, in operation of the cutting unit 20, and during the shifting of the saw blade 22 from the second working state to the folded state, the movable pin 50 is automatically moved, by its weight, through the curve slot portion 483, to the second slot portion 482, and retains the retained portion 243 of the trigger 24 so as to prevent an undesired operation of the trigger 24 for triggering the switch 25.

As illustrated, the miter saw has a simple and compact construction and can be conveniently manufactured and fabricated with a folding power-off protection function.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A miter saw comprising:
a base seat unit including a worktable which has a working surface, and a pivot seat which is connected with said worktable, said pivot seat defining a pivot axis;
a cutting unit including a support arm which is pivotably mounted on said pivot seat about the pivot axis, a saw blade which is rotatably mounted on said support arm to be rotated about a blade axis, a driver which is mounted on said support arm to drive rotation of said saw blade, a trigger which is pivotably mounted on said support arm, and a switch which is mounted on said support arm and which is triggered by said trigger to turn-on and turn-off said driver, said cutting unit being operated to rotate relative to said pivot seat about the pivot axis to rotate said saw blade relative to said working surface among a first working state, where said saw blade is disposed substantially perpendicular to said working surface, a second working state, where said saw blade is tilted relative to said working surface, and a folded state, where said saw blade is disposed substantially parallel to and close to said working surface; and
a safety unit mounted on said support arm adjacent to said trigger, said safety unit including at least one slide slot and a movable pin which is engaged with and slidable along said slide slot, said slide slot having a first slot portion, a second slot portion which is opposite to said first slot portion in a first direction that is substantially parallel to the blade axis, and a curve slot portion which interconnects said first and second slot portions, said safety unit having a retaining portion which is bordered by said curve slot portion and a reference plane that passes through said first slot portion and said second slot portion;
wherein, when said saw blade is disposed in the first working state to have the blade axis be substantially parallel to said working surface, said movable pin is obstructed by said retaining portion and retained to said first slot portion, and said trigger is operable to trigger said switch,
wherein, when said saw blade is disposed in the second working state to have the blade axis extending to inclinedly intersect an extension plane of said working surface, said movable pin is obstructed by said retaining portion and retained to said first slot portion, and said trigger is operable to trigger said switch, and
wherein, when said saw blade is rotated from the second working state to the folded state to have the blade axis extending to substantially intersect the extension plane of said working surface perpendicularly, said movable pin is moved, by its weight, through said curve slot portion, to said second slot portion below said first slot portion, and said movable pin locks said trigger to prevent operation of said trigger for triggering said switch.

2. The miter saw of claim 1, wherein said safety unit includes a slot forming seat which is securely mounted on said support arm, said slide slot being formed in said slot forming seat, said slot forming seat having a first side, a second side opposite to said first side in the first direction, a lower end connected between said first and second sides, and an upper end opposite to said lower end, said slide slot having a first inclined slot section which is formed adjacent to said first side, a crossing slot section which is formed adjacent to said upper end and in communication with said first inclined slot section, and a second inclined slot section which is formed adjacent to said second side and in communication with said crossing slot section, said first slot portion being disposed in said first inclined slot section and adjacent to said lower end, said first inclined slot section extending from said first slot portion towards said crossing slot section and away from said first side, said second slot portion being disposed in said second inclined slot section and adjacent to said second side, said second inclined slot section extending from said second slot portion towards said crossing slot section and away from said second side such that said first inclined slot section, said crossing slot section and said second inclined slot section cooperatively define said curve slot portion, and cooperate with said reference plane to define on said slot forming seat said retaining portion of a substantially trapezoidal shape, said trigger having a pivot end which is pivotally connected with said support arm, and a swing end opposite to said pivot end, said swing end having a retained portion which is disposed proximate to said second slot portion, and a protrusion which protrudes from said retained portion and is disposed proximate to said retaining portion.

3. The miter saw of claim 2, wherein said slide slot further has an entrance section which extends from said first side to be in communication with said first inclined slot section, said entrance section having at said first side an access port which is located in a height position between said first slot portion and said upper end, said entrance section and said first inclined slot section being cooperatively formed with a cross-section of a V-shape.

4. The miter saw of claim 3, wherein said slot forming seat includes two upright walls which are spaced apart from each other in a second direction that is perpendicular to the first direction, a connecting wall which interconnects said upright walls, and a connecting rib which interconnects said upright walls and which is spaced apart from said connecting wall in the first direction, said upright walls, said connecting wall and said connecting rib cooperatively defining a guide slot thereamong, said connecting wall having a through hole which extends therethrough and is in communication with said guide slot, each of said upright walls being formed with said at least one slide slot, said safety unit further including a returning member, said returning member having a movable piece which is received in and movable along said guide slot in the first direction, and an operated rod which is connected with said movable piece to be movably engaged in said through hole, said movable piece having an elongated slot which extends in a third direction that is perpendicular to both the first direction and the second direction, said movable pin being engaged in and movable along said elongated slot, said operated rod having an operated end which projects from said through hole and outwardly of said support arm when said movable pin is moved to said second slot portion.

5. The miter saw of claim 4, wherein said movable piece of said returning member has an inverted-U shaped cross-section, said elongated slot having an upper closed end and a lower opened end which are disposed proximate to said upper and lower ends, respectively.

6. The miter saw of claim 5, wherein said movable pin has a shaft extending in the second direction, two discs respectively connected with two ends of said shaft, and an interfering portion extending from one of said discs in the second direction, said shaft being inserted into said slide slots from said entrance sections to have said discs respectively disposed outwardly of and abutting against said upright walls, said interfering portion being engaged with said retained portion of said trigger when said movable pin is moved to said second slot portion.

7. The miter saw of claim 2, wherein said retaining portion of said safety unit has a first inner inclined edge which borders a lower end of said first inclined slot section, an inner crossing edge which borders a lower end of said crossing slot section, and a second inner inclined edge which borders a lower end of said second inclined slot section.

8. The miter saw of claim 7, wherein said inner crossing edge of said retaining portion is in form of a step, and includes an inner lower edge segment which is proximate to said first inclined slot section, an inner higher edge segment which is proximate to said second inclined slot section, and an inner inclined edge segment which interconnects said inner lower and higher edge segments.

9. The miter saw of claim 8, wherein said slot forming seat has a first outer inclined edge, an outer crossing edge and a second outer inclined edge, said first outer inclined edge being spaced apart from said first inner inclined edge to border an upper end of said first inclined slot section, said outer crossing edge being spaced apart from said inner crossing edge to border an upper end of said crossing slot section, said second outer inclined edge being spaced apart from said second inner inclined edge to border an upper end of said second inclined slot section, said outer crossing edge being in form of an inverted step, and including an outer higher edge segment which is proximate to said first inclined slot section, an outer lower edge segment which is proximate to said second inclined slot section, and an outer inclined edge segment which interconnects said outer higher and lower edge segments.

10. The miter saw of claim 6, wherein said support arm has a bracket disposed adjacent to said slot forming seat, said safety unit further including a magnet member which is mounted on said bracket, said movable pin further having an magnetically attractive portion which is connected with and extends from the other one of said discs in the second direction to be retained by said magnet member when said movable pin is moved to said second slot portion.
